(19) United States
(12) Patent Application Publication
(10) Pub. No.: US 2013/0015656 A1
(43) Pub. Date: Jan. 17, 2013

(54) HIGH-PRESSURE CONNECTION DEVICE FOR PIPE AND HOSE LINES WITH A BAYONET COUPLING

(71) Applicants: Dieter Ehrke, Bielefeld (DE); Carsten Schippers, Bielefeld (DE); Thomas Müller, Gutersloh (DE); Oliver Neiske, Verl (DE)

(72) Inventors: Dieter Ehrke, Bielefeld (DE); Carsten Schippers, Bielefeld (DE); Thomas Müller, Gutersloh (DE); Oliver Neiske, Verl (DE)

(21) Appl. No.: 13/344,849

(22) Filed: Jan. 6, 2012

(30) Foreign Application Priority Data
Jan. 7, 2011 (DE) 10 2011 08 084.8

(51) Int. Cl. F16L 37/107

(52) U.S. Cl. 285/316; 285/315

(57) ABSTRACT

A high-pressure connection device for pipe and hose lines with a connection body and a pipe-like end piece insertable into the connection body, including a union nut externally mounted to the connection body, which can be rotated between a released position and a mounted position. Form-locking designs, which act like a bayonet coupling, are arranged on the connection body and union nut in the form of projections on the union nut as well as in the form of interlocking contours formed on an end extension of the connection body for the locking reception of the projections when rotating the union nut. A security element is movable between a secure position and a release position for rotation of the union nut in order to prevent unintentional reverse rotation of the union nut.

The invention concerns a high-pressure connection device for pipe and hose lines with a connection body. This has a hole for the throughput of the medium flowing through the pipe or hose line. Further, it has a pipe-like end fitting which can be rotated between a released position and a mounted position via a union nut externally mounted to the connection body, and it can be plugged onto the front end of the connection body.

A connection device with the aforementioned properties is, for example, described in DE 102 06 684 B4. As a connector body, the connection device has a screw-fitting body with a male thread used for connecting an insertable pipe end with its open end into the accordingly formed screw-fitting body. There is a threaded union nut at the end of the pipe for achieving its mounted position on the external thread of the screw-fitting body, whereby the union nut acts upon an internal supporting clamp ring arranged between the screw-fitting body and union nut, which, when the union nut is screwed to the screw-fitting body, creates a clamp load on the pipe end through the union nut.

The pipe end is simultaneously fixed to the screw-fitting body by screwing the union nut to the screw-fitting body. Due to the arrangement of the compressible clamp ring, it is possible with this connection device to create the pipe connection via a screw motion of the union nut by less than one revolution. The additional mounting of a compressible clamp ring to be set into the union nut is disadvantageous, as it causes additional manufacturing and assembly costs. Further, such a clamp connection is single use, because the clamp ring is highly stressed.

The purpose of the invention, therefore, is to provide a connection device with the aforementioned properties that continues to allow the connection to be formed with only a partial rotation of the union nut, but that has a simpler design and can be used as many times as desired.

The solution to this problem, including advantageous designs and developments of the invention, results from the content of the patent claims that follow this description.

In its basic idea, the invention stipulates that for the connection of a union nut, which supports itself a rotationally symmetrical shoulder externally formed on the pipe-like end piece, and the connection body, form-locking designs which act like a bayonet coupling are formed on the connection body and union. They are in the form of projections on the union nut as well as in the form of interlocking contours formed on an end extension of the connection body for the locking reception of the projections when rotating the union nut opposite the connection body.

It also provides for a security element that is movable between a securing position and released position for the rotation of the union nut in order to prevent the unintentional reverse rotation of the union nut from its mounted position into its released position. The invention has the further benefit that, due to the unusual fallback on the principle of a bayonet coupling, well-known in other applications, for a generic connection device. This means it is possible to use the advantage of such a design, namely the assembly of the connection device with only a partial rotation of the involved components against each other, even for a generic connection device. In doing so, the union nut is supported on an external, rotationally symmetric, shoulder on the pipe-like end piece, so that the union nut in its mounted position inserts the pipe-like end piece into the formed female end of the connection body. As there is the known risk of an unintentional or automatic release of the connection in a bayonet coupling design, which cannot be allowed for a pressurized pipe connection, in addition to the form-locking design of the bayonet coupling there is also a securing element provided, which in its secured position prevents an unintentional or automatic backturn of the union nut to its released position.

The invention is equally suitable for a pipe connection, where a pipe expansion has been formed on the pipe end that is insertable into the female end of the connection body and upon which the union nut is supported.

However, especially for the connection of hose lines, a pipe-like end piece can also be used with a rotationally symmetrical shoulder formed on its outer periphery, in which the inner pipe diameter remains unchanged, in contrast to a pipe expansion formed by deformation.

In order to form the bayonet coupling type connection, in detail it can be designed so that at least two radial, inwardly-directed projections, arranged distanced with interspersed open areas between each other, are fitted on the union nut in the area to be turned on the end extension of the connection body. It can also be designed in such a way that the interlocking contours arranged on the union nut projections coincide with insertion slots in the locking slots running in the circumferential direction of the surface of the end extension, through which the projections formed on the union nut can be axially inserted. Here, the locking slots in the directional rotation of the union nut from the released position to the mounted position can exhibit a starting angle emanating from the arranged insertion slot, as well as an end stop-limited rear grip section for the union nut projections.

According to the alternative design forms of the invention, it can be stipulated that the interlocking contours, which form a portion of the bayonet coupling and are arranged on the connection body, are integrally formed on the end extension of the connection body. It is also possible that a separate bayonet sleeve is provided as a carrier of the interlocking contours and part of the bayonet coupling on the connection and is firmly affixed to the end extension.

With regard to the design of a security element, it can be stipulated according to an invention design example that the security element consists of a non-rotatable, but axially-movable locking ring, pre-stressed via spring force in its secured position, mounted to the end extension of the connection body or the bayonet sleeve, which engages the union nut with at least one of the axial locking projections in the mounted position and fixes this against backturn.

For this, the locking projections arranged on the locking ring can axially protrude in the direction of the union nut and be arranged on the locking ring so that the locking projections lie in the insertion slots formed on the end extension of the connection body and engage in the open spaces formed between their projections when the union nut is in the mounting position.

With regard to guiding the movable locking ring on the connection body or its end extension or bayonet sleeve, it can be stipulated that engaging guide rails are arranged on the outer periphery of the end extension and the bayonet sleeve extending in axial direction and engaging in guide slots correspondingly arranged on the locking ring.

Insofar as the locking ring is to be pre-stressed by spring force in its securing position, it can be stipulated that the spring force is exerted via spring arms, which are integrally formed on the locking ring and are frontally supported against the connection body. It can alternatively be stipulated that the spring force for pre-stressing the locking ring into its securing position is exerted via a spring body supported between the locking ring and the connection body. In alternative design forms, for example, a waved washer or another commercially available spring element, such as a compression spring, can be used as a spring body. Even the arrangement of an elastic rubber seal ring may be sufficient.

In order to avoid damage to the locking ring in the case of a violent back turn of the union nut to its released position when it is engaged with the union nut, it can, according to a design example of the invention, be stipulated) that the surfaces of the projections located on the union nut and the locking ring are designed as angular faces that push the locking ring into the released position when the union nut is turned into the unlocked position.

According to an alternative design form regarding the design of the securing element, it can be stipulated that the securing element consists of a non-rotatable sliding sleeve attached to the outer periphery of the union nut that is axially movable between the released position and the secured position. The slid on secured position of the securing element is on the end extension of the connection body, engaged with at least one of the radial-projecting locking lugs attached to the end extension or bayonet sleeve in such a way that turning back the sliding sleeve with the coupled union nut (which cannot be turned against the sleeve) into the released position is prevented.

According to a first design example of the invention, it can be stipulated that the sliding sleeve with an inner contour formed on it runs over the locking projection so that there is a form closure between the locking lug and the sliding sleeve.

Alternatively, it can be stipulated that the sliding sleeve has at least one sprung, inwardly directed hook at its free end facing the connection body. In the released position of the union nut hook, this hook is kept in a formed indentation on the end of the union nut facing the connection body and, on moving the sliding sleeve on the union nut, it can be moved from the indentation. When the sliding sleeve is shifted in the direction of the connection body, the hook lies spring-loaded on the front edge of the union nut, on the circumference of the end extension or bayonet sleeve, and is on the same plane next to the locking lug so that the locking lug, when the sliding sleeve is moved forwards, prevents its rotation in the direction of the union nut released position.

After assembling the connection by rotating the union nut into the mounting position, the sliding sleeve is manually pushed forward into its securing position in the direction of the connection body, whereby the inwardly pre-tensioned hooks slide over the surface of the end extension or the bayonet sleeve. In the securing position of the sliding sleeve, the hooks lie level to the locking lugs formed on the end extension or bayonet sleeve so that a rotation of the sliding sleeve with the coupled non-rotating union nut is prevented. An unintentional or automatic sliding back of the sliding sleeve into its released position is prevented, as each hook, due to its pre-tension, is latched to the front end of the union nut and must be somewhat expanded through displacement pressure until it slides back into the indentation.

The drawing provides design examples of the invention, which are described hereinafter. These include:

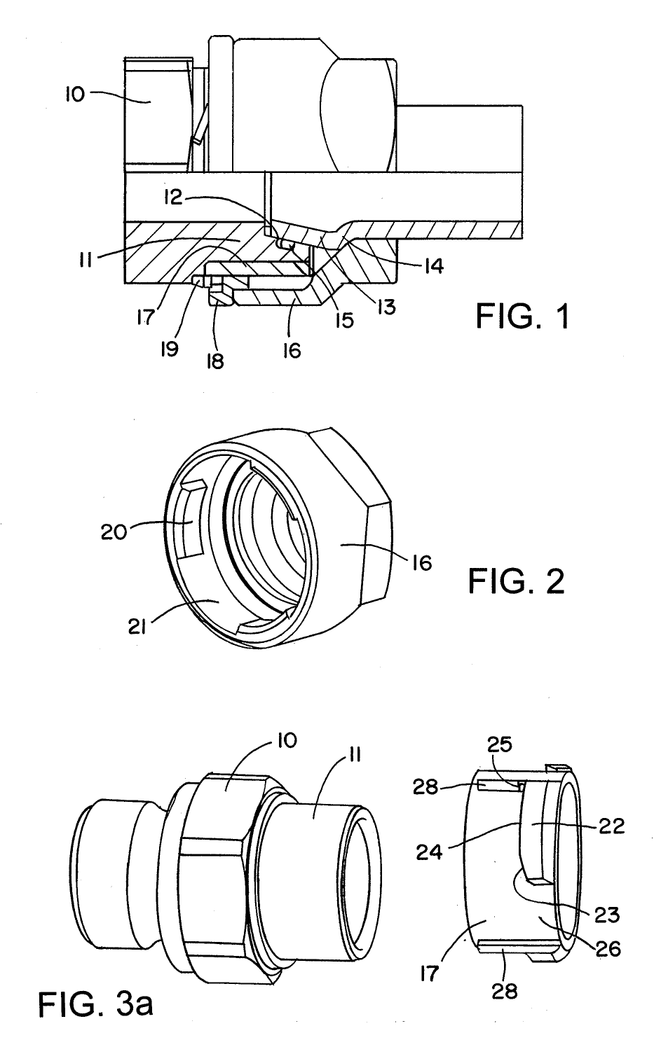

FIG. 1 a connection device in its mounting position with the connection body and union nut sitting atop it in a partially sectioned side view,

FIG. 2 the union nut of the pipe connection according to FIG. 1 in a single perspective view,

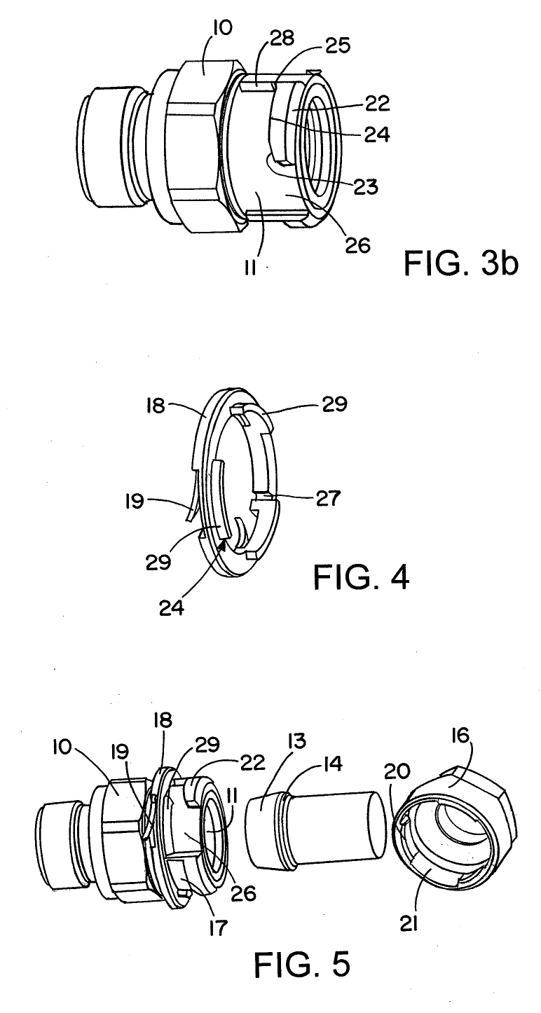

FIG. 3a a bayonet sleeve in a single perspective view with interlocking contour towards the connection body,

FIG. 3b the interlocking contours apparent from FIG. 3a in immediate direct mounting to the end extension of the connection body,

FIG. 4 a locking ring belonging to the pipe connection according to FIGS. 1 to 3 in a single perspective view,

FIG. 5 the components involved in the connection device according to FIG. 1 in a single exploded view,

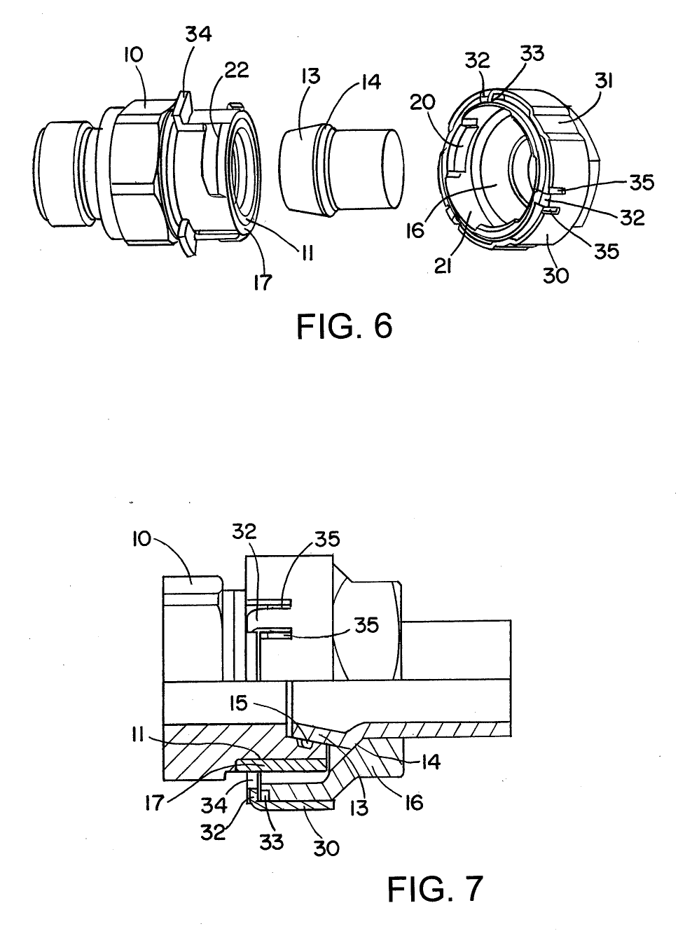

FIG. 6 an alternative design form of the connection device with a movable sliding sleeve fitted to the union nut as a securing element in a representation according to FIG. 5,

FIG. 7 the object of FIG. 6 with mounted connection device.

The pipe connection seen in FIG. 1 in the mounting position shows a connection body 10 containing a formed hole for the through flow of the medium through the pipe connection, which has an end extension 11 with a recess 12 formed on its inside for a pipe end 13 to be placed in the connection body 10. In the represented design example, the connecting pipe has an arranged pipe expansion 14 spaced to the pipe end 13 for the formation of a rotationally symmetrical shoulder on the pipe end 13, whereby the pipe end 13 introduced into the recess 12 is sealed via a sealing ring 15 arranged in the recess 12 against the connection body 10 or its end extension 11. The pipe expansion 14 is made by means of a corresponding deformation of the pipe end 13, whereby the inner diameter of the pipe changes. What is not shown is that a pipe-like end piece can be used for the connection, in particular for connecting a hose line with the connection body 10, which can be inserted into recess 12 of the connection body 10 as pipe end 13 and which has a connector design for a hose line. In such a case, the rotationally symmetrical shoulder on the outer periphery of the pipe-like end piece is formed similarly to the pipe expansion 14 seen in FIG. 1, whereby the inner flow path remains unchanged in this case.

A union nut 16 is inserted onto the pipe, which supports itself on the pipe expansion 14 when attached to the connection body 10 and inserts the pipe end 13 into the recess 12 exerting a corresponding axial force component. To affix the union nut 16 to the connection body 10, a bayonet sleeve 17 is inserted onto the end extension 11 and affixed to the end extension 11. This is done, for example, by welding, soldering, gluing or pressing, whereby the form-locking designs required to produce a bayonet connection are attached to the bayonet sleeve in a manner yet to be described. Further, FIG. 1 shows a sliding locking ring 18 axially on the bayonet sleeve 17, which is supported against the connection body by means of spring arms 19 attached to it projecting towards the connection body 10 and which engages with at least one locking projection 29 into the union nut 16 and locks it against rotation in a manner yet to be described.

As is furthermore apparent from FIG. 2, the union nut 16 has three equally spaced, radial, inwardly directed projections 20 with open surfaces 21 in between them in the area to be turned onto the end extension 11 of the connection body 10.

On the bayonet sleeve 17, visible from FIG. 3a, interlocking contours are formed corresponding to the projections 20 or open spaces 21, which consist of locking slots running in the peripheral direction arising from the surface of the bayonet sleeve 17 with insertion slots 26 in between for the axial throughput of the projections 20 of the union nut. In a known manner, the locking slots 22 have a starting angle 23 emanating from the arranged insertion slot 26 in the rotation direction of the union nut 16 from the released position to the mounted position, as well as an end stop-limited 25 rear grip section 24.

As seen from FIG. 3b, the locking contours 22, 23, 24 and 25 involved in the formation of the bayonet coupling can also be individually arranged with or on the end extension 11.

As seen from the accompanying FIG. 4, the axially on the bayonet sleeve 17 movable locking ring 18 shows correspondingly arranged guide slots 27, into which guide rails 28 formed on the bayonet sleeve 17 are engaged, which originate from the end stops 25 of the locking slots 22. Further, protruding locking projections 29 are axially arranged on the locking ring 18 in the direction of the union nut 16 in such a way that the locking projections 29 fit in their circumferential extension in the open spaces between the projections 20 of the union nut 16. The guidance of the locking ring 18 is due to the engagement of the guide rails 28 in the guide slots 27 on the bayonet sleeve non-rotating.

As evident from a comparison of FIGS. 1 to 4 in conjunction with FIG. 5, the union nut 16 is inserted on the bayonet sleeve 17 to assemble the connection device. This is done so in a position in which the projections 20 of the union nut 16 pass through the insertion slots 26 of the bayonet sleeve 17. Here, the projections 20 simultaneously stress the locking projections 29 of the locking ring 18 lying behind the insertion slots 26 of the bayonet sleeve 17 and push back the locking ring 18 against the spring force of its spring arms 19 in the direction of the connection body 10. Once the projections 20 of the union nut 16 have achieved the starting angles 23 of the locking slots 22, the union nut 16 can be rotated against the bayonet sleeve 17 so that the projections 20 are guided over the starting angles 23 in the respective rear grip section 24 of the locking slots 22 until reaching the end stop 25. Once the projections 20 have reached the full overlap with the rear grip sections 24 of the locking slots 22, then the respective insertion slots 26 of the bayonet sleeve 17 are released so that, due to the pre-tension exerted by the spring arms 19, the locking ring 18 can now slip with its locking projections 29 into the open surfaces 21 between the projections 20 of the union nut 16. In this position, the union nut 16 is secured against a backturn due to the blockade of its projections 20 by the locking projections 29 of the locking ring 18.

In order to avoid the destruction of the locking ring 18 engaged with the union nut 16 in the case of a violent backturn of the union nut 16 to its released position, the abutting surfaces of the projections 20 as well as the locking projections 29 can be designed as inclined surfaces (not shown in detail) so that when applying a sufficiently large amount of torque, the union nut 16 upon a starting backturn to its released position axially presses the locking ring 18 out of engagement.

The design form described above has the advantage that the mounting state is simultaneously recognized, because the position of the locking ring 18 engaged in the union nut 16 is detectable by the existing gap between this and the connection body 10. If the periphery of the end extension 11 guiding or supporting the locking ring 18 or the correspondingly arranged bayonet sleeve 17 is color-coated at this point, the visual reliability of detection would be improved.

In order to release the connection, the locking ring 18 must be slid against the force of its spring arm 19 to disengage with the union nut 16. This may take place either manually or using specific tools.

FIGS. 6 and 7 represent an alternative design form of the invention. Here, a movable sliding sleeve 30 is attached to the outer periphery of the union nut 16, which is located on the depressions 31 and therefore non-rotatable, but is axially movable on the union nut 16. The sliding sleeve 30 is movable between a release position fully seated on the union nut 16 and a secure position for the union nut 16 pushed in the direction of the connection body 10. In the illustrated design example, three hooks 32 are formed by the arrangement of spaced free cut-outs 35 on the outer periphery of the sliding sleeve on the front edge facing the connection body 10. The hooks are provided with an inwardly angled hook area that correspondingly projects over the wall thickness of the sliding sleeve 30. The hook areas are sized such that they protrude inwardly over the front edge of the union nut 16.

As evident from a comparison of the FIGS. 6 and 7, the hooks 32 are in the released position of the sliding sleeve 30 in an indentation 33 formed on the front edge of the union nut 16, whereby the hooks 32 are spring-loaded and arched due to the rising of their hook areas so that the hooks 32 are released from the indentation 33 of the union nut 16 following the advancement of the sliding sleeve 30 in the direction of the connection body 10, and snap inwardly over the its front edge. In this advanced position, the hooks 32 slide over the surface of the end extension 11 or the bayonet sleeve 17. In the forward shifted secured position, the hooks 32 then lie on one peripheral level with the locking lugs that are attached to the end extension 11 or the bayonet sleeve 17 and project radially outwards. The end stops 25 of the locking slots 22 prevent a rotation of the union nut 16 with the non-rotatable sliding sleeve 30 affixed atop it in the one rotational direction in its mounted position. Rotation in the opposite direction in the released position is prevented by the arrangement of the hooks 32 formed on the sliding sleeve 30 against the locking lugs 34 of the end extension 11 or bayonet sleeve 17. An automatic backslide of the sliding sleeve 30 from the secured position shown in FIG. 7 is prevented through the hooks 32 located on the sliding sleeve 30, which cannot slide automatically into the indentation 33 of the union nut 16.

In fact, a certain shifting force must be actively applied to bring the hooks 32 over the front edge of the sliding sleeve 30 into the indentation 33.

The properties of the subject of these documents published in this description, the patent claims, the summary and the drawings can be essential separately or in any combination for the realization of the invention in its various design forms.

1. Connection device that is safe at high pressures for pipe or hose lines, comprising a connector body having a borehole for transmitting the medium that flows through the pipe or hose line, and comprising a tube-like end piece that can be inserted into a receptacle formed at the front end of the connector body and secured there by means of a union nut placed on the outside of the connector body so as to turn between a loose setting and an assembled setting, characterized in that for connecting itself on an outer rotationally symmetric shoulder, formed on the tube-like end piece, a bracing union nut and connector body with each other on connector body and union nut form-locked configurations acting jointly in the manner of a bayonet lock in the form of catches formed on the union nut as well as of locking contours placed on a end extension of connector body for locking receipt of the catches when the union nut is twisted are arranged, and to prevent unintended reverse turning of the union nut from its mounted setting into its loosened setting, a sliding securing element is provided between a safety setting and a release setting for turning of the union nut.

2. Connector device secure at high pressures according to claim 1, characterized in that on the union nut in its area to be turned on the end extension of the connector body, two catches directed radially inwards toward each other at an interval are placed with free surfaces lying between, and that the locking contours assigned to the catches of the union nut consist of locking strips running projecting from the surface of the end extension in the peripheral direction of the end extension with insertion paths lying between, for axial sliding through of the catches formed on the union nut.

3. Connector device secure at high pressures according to claim 2, characterized in that the locking strips in the turning direction of the union nut directed out of the loosened setting into the assembled setting has a stop slant proceeding from the assigned insertion path as well as a rear gripping section limited by an end stop for the catches of the union nut.

4. Connector device secure at high pressures according to claim 1, characterized in that the locking contours forming a part of the bayonet lock and arranged on the connector body are configured as a single piece on the end extension of connector piece.

5. Connector device secure at high pressures according to claim 1, characterized in that a separate bayonet sheath is provided as the carrier of the locking contours forming a part of the bayonet lock and placed on the connector body and is securely connected with the end extension.

6. Connector device secure at high pressures according to claim 1, characterized in that the securing element consists of a locking ring that is placed so as not to turn on the end extension of the connector body or the bayonet sheath respectively, but can move axially, which is pre-tensioned by spring force in its safety setting, in which the locking ring with at least one locking projection attached axially on it, engages into the union nut when the union nut is twisted into its mounted setting and secures it against turning back.

7. Connector device secure at high pressures according to claim 6, characterized in that the locking projections placed on the locking ring project axially in the direction of the union nut and are arrayed on the locking ring so that the locking projections lie in the insertion path formed on the end extension of the connector body and, in the mounted setting of the union nut, engaged into the free surfaces there formed between their catches.

8. Connector device secure at high pressures according to claim 6, characterized in that on the outer periphery of the end extension or bayonet sheath respectively, guide strips are placed that extend in an axial direction and engage in guide slots correspondingly placed on the locking ring.

9. Connector device secure at high pressures according to claim 6, characterized in that the spring force is exerted for pre-tensioning the locking ring in its safety setting by means of a spring arm that is shaped in a single piece on the locking ring, and that is braced on its front side against the connector body.

10. Connector device secure at high pressures according to claim 6, characterized in that spring force is exerted for pre-tensioning the locking ring in its safety setting by means of a spring body braced between the locking ring and the connector body.

11. Connector device secure at high pressures according to claim 1, characterized in that the surfaces adjoining one another of the catches found on the union nut and of locking projection carried by the locking ring are configured as slanted surfaces that, when the locking ring is twisted to the loose setting of the union nut, glide past one another and push the locking ring axially out of engagement with the union nut.

12. Connector device secure at high pressures according to claim 1, characterized in that the securing element consists of a sliding sleeve placed so as not to turn on the outer periphery of the union nut and guided so as to shift axially between the release setting and the safety setting for the union nut, which [sleeve] in its safety setting slid onto the end extension of the connector body compels contact with at least one locking catch attached on the end extension or bayonet sheath respectively, projecting from it radially, so that the sliding sleeve is prevented from turning back into the loose setting, of the union nut, with the union nut coupled thereon so as not to turn.

13. Connector device secure at high pressures according to claim 12, characterized in that the sliding sleeve passes over the locking catch with an interior contour formed on it, producing a form lock between the locking catch and the sliding sleeve.

14. Connector device secure at high pressures according to claim 12, characterized in that the sliding sleeve on its free end turned toward the connector body has at least one hook configured to be spring-loaded and directed inwards, which in the release setting for the union nut is held in a recess formed on the end of the union nut facing the connector body and when the sliding sleeve is slid on the union nut on the one hand is able to be extended out of the recess and on the other hand, with a sliding sleeve shifted in the direction of the connector body, it overlaps the front edge of the union nut in spring-loaded fashion, rests on the periphery of the end extension or bayonet sheath respectively, and stands in a peripheral plane next to the locking catch, so that the locking catch in the forward-shifted setting of the sliding sleeve precludes turning of it in the direction of the loose setting of the union nut.
